(19) United States
(12) Patent Application Publication
(10) Pub. No.: US 2022/0332469 A1
(43) Pub. Date: Oct. 20, 2022

(54) Paint Pouring Device

(71) Applicant: George Jaggers, Laurel, DE (US)

(72) Inventor: George Jaggers, Laurel, DE (US)

(21) Appl. No.: 17/720,679

(22) Filed: Apr. 14, 2022

Related U.S. Application Data
(60) Provisional application No. 63/175,096, filed on Apr. 15, 2021.

(51) Int. Cl. B65D 25/48

(52) U.S. Cl. CPC B65D 25/48

(57) ABSTRACT

A device for engaging the rim of a paint can to prevent paint from spilling down the sides of the paint can while pouring paint. The paint pouring device flexibly engages a rim of a paint can. A paint pouring guide attaches either to the paint can or a cylindrical body of the paint pouring device. The cylindrical body slips over the rim of the paint can and holds the paint pouring device in place via friction. A curved body of the paint pouring guide engages either the cylindrical body or the rim of the paint can directly. A pair of wings of the paint pouring guide extend upward and outward from the cylindrical body terminating in a pour tip for directing a flow of paint out of the can.

### CROSS-REFERENCE TO RELATED APPLICATION

The present application claims priority to, and the benefit of, U.S. Provisional Application No. 63/175,096, which was filed on Apr. 15, 2021 and is incorporated herein by reference in its entirety.

### FIELD OF THE INVENTION

The present invention generally relates to a pouring device for paint, and more specifically to a device attachable to a paint can or paint container to prevent dripping. Accordingly, the present specification makes specific reference thereto. However, it is to be appreciated that aspects of the present invention are also equally amenable to other like applications, devices, and methods of manufacture.

### BACKGROUND OF THE INVENTION

Paint refers to any pigmented liquid, liquefiable, or solid mastic composition that, after application to a substrate in a thin layer, converts to a solid film. Paint is typically used to protect, color, or provide texture to objects. Paint can be made or purchased in many colors and different types, such as watercolor or synthetic. Paint is typically stored, sold, and applied as a liquid, but most types dry into a solid. Most paints are either oil-based or water-based and each have distinct characteristics.

Paint is generally stored in metal cans or plastic jugs or buckets of varying sizes. The one gallon metal can is the most commonly used storage container. The typical paint can is a cylindrical container that terminates in a top opening having a rim or lip. The rim has a groove that runs around the rim configured to accept a lid. A lip of the lid is pressed into the groove to seal the paint can. The lid is then pried off the container to access the paint. The groove in the container catches a small amount of paint when poured.

Unfortunately, pouring paint from a paint can be a messy and frustrating experience. Paint is poured over the lip of the can and typically continues to drip down the sides after pouring is complete. This requires the pourer to constantly clean the sides of the paint container with a brush or rag to stop the dripping. The paint can also eventually drip onto the floor causing a mess and requiring additional cleanup.

Accordingly, there is a great need for an attachment for a paint can designed to prevent excess paint from leaking down the sides of the can. There is also a need for a way for to pour paint out of a can without the need to constantly clean the can's exterior. Similarly, there is a need for a way to ensure that all of the paint in a can is available for application purposes rather than being wasted. Further, there is a need for a device that can conveniently attach to the sides of a paint can or container.

In this manner, the improved paint pouring device of the present invention accomplishes all of the forgoing objectives, thereby providing an easy solution for pouring paint out of a paint can without making a mess. A primary feature of the present invention is an attachment for engaging a paint can rim that seals against the paint can sides. The present invention allows the user to easily place a pouring guide on a paint can that is also easily removable for cleaning. Finally, the improved paint pouring device of the present invention is capable of preventing the waste of paint caused by drips and spills.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a paint pouring device. The paint pouring device comprises a cylindrical body and a paint pouring guide. The cylindrical body fits over a rim and frictionally engages a sidewall of a paint can. The cylindrical body is flexible and comprises a top, and inner sidewall, and an outer sidewall. The inner and outer sidewalls are connected by the top. The top of the cylindrical body may comprise a lip or be beveled inward.

The cylindrical body further comprises a bottom. The bottom is grooved to fit over the rim of the paint can. The bottom is generally U-shaped or horseshoe shaped. The bottom comprises an inner bottom sidewall and an outer bottom sidewall connected by a rim engaging portion. The inner and outer bottom sidewalls are separated, and with the rim engaging portion form a groove or channel that fits around and frictionally engages the rim and sidewall of the paint can. The inner bottom sidewall may comprise a sealing element. The sealing element seals the inner bottom sidewall against the sidewall of the paint can to prevent paint leakage between the inner bottom sidewall and the paint can sidewall.

The paint pouring guide comprises a curved body and a pouring body. The paint pouring guide extends upward and away from the cylindrical body. The curved body comprises an inner sidewall engaging portion and a top portion. The inner sidewall engaging portion is positioned against and attached to a portion of the inner sidewall of the cylindrical body. The top portion fits and is attached to over a portion of the top of the cylindrical body. Alternatively, the curved body may be integrated directly into the top and inner sidewall of the cylindrical body.

The pouring body comprises a pair of wings and a pour tip. The pair of wings wedge or bend inward to terminate in the pour tip. The pouring body extends upward and away from the curved body. The pouring body may be malleable or flexible to adjustably direct a flow of paint out of the paint can, funnel it across the pouring body, and over the pour tip. Alternatively, the pouring body may be rigid.

In an alternative embodiment, the paint pouring device comprises a paint pouring guide that is independent of any cylindrical body. The paint pouring guide fits over a rim and frictionally engages a sidewall of a paint can. The paint pouring guide comprises a curved body and a pouring body integrated with or attached to the curved body. The paint pouring guide extends upward and away from the rim of the paint can.

The curved body comprises an inner sidewall engaging portion, an outer sidewall engaging portion, and a top portion. The top portion connects the inner and outer sidewall engaging portions. The curved body is grooved to fit over and frictionally engage a portion of the rim of the paint can similar to the bottom of the cylindrical body of the previous embodiment of the paint pouring device.

The pouring body comprises a pair of wings and a pour tip. The pair of wings wedge or bend inward to terminate in the pour tip. The pouring body is attached to or otherwise integrated with the curved body, extending upward and away from the curved body. The pouring body is malleable and flexible to adjustably direct a flow of paint out of the paint can, funnel it across the pouring body, and over the pour tip.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a paint pouring device of the present invention for pouring paint out of a paint can in accordance with the disclosed architecture.

FIG. 2 illustrates an underneath perspective view of one potential embodiment of the paint pouring device of the present invention for pouring paint out of a paint can in accordance with the disclosed architecture.

FIG. 3 illustrates a side view of one potential embodiment of the paint pouring device of the present invention for pouring paint out of a paint can secured to the paint can in accordance with the disclosed architecture.

FIG. 4 illustrates a front view of one potential embodiment of the paint pouring device of the present invention for pouring paint out of a paint can secured to the paint can in accordance with the disclosed architecture.

FIG. 5 illustrates an overhead view of one potential embodiment of the paint pouring device of the present invention for pouring paint out of a paint can in accordance with the disclosed architecture.

FIG. 6 illustrates a rear perspective view of one potential embodiment of the paint pouring device of the present invention for pouring paint out of a paint can secured to the paint can in accordance with the disclosed architecture.

FIG. 7 illustrates an exploded view of the various components of one potential embodiment of the paint pouring device of the present invention for pouring paint out of a paint can in accordance with the disclosed architecture.

FIG. 8 illustrates a rear perspective view of one potential embodiment of the paint pouring device of the present invention for pouring paint out of a paint can secured to the paint can in accordance with the disclosed architecture.

FIG. 9 illustrates a partial section view of a cylindrical body of one potential embodiment of the paint pouring device of the present invention for pouring paint out of a paint can engaging a rim of the paint can in accordance with the disclosed architecture.

FIG. 10A illustrates a partial section view of the cylindrical body of one potential embodiment of the paint pouring device of the present invention for pouring paint out of a paint can in accordance with the disclosed architecture.

FIG. 10B illustrates a partial section view of the cylindrical body of one potential embodiment of the paint pouring device of the present invention for pouring paint out of a paint can opening to engage a rim of a paint can in accordance with the disclosed architecture.

FIG. 10C illustrates a partial section view of an alternative configuration of the cylindrical body of one potential embodiment of the paint pouring device of the present invention for pouring paint out of a paint can in accordance with the disclosed architecture.

FIG. 10D illustrates a partial section view of an alternative configuration of the cylindrical body of one potential embodiment of the paint pouring device of the present invention for pouring paint out of a paint can in accordance with the disclosed architecture.

FIG. 11 illustrates a rear perspective view of a paint pouring guide of one potential embodiment of the paint pouring device of the present invention for pouring paint out of a paint can secured to the paint can in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a paint can attachment device that can attach to the side of a paint can or container via a groove. The device comprises a rubber lip attachment for a paint can that has a rubber tip and a wedge. Paint can be poured via the tip which prevents paint from spilling down the sides of the can while pouring. The device is also usable to remove excess paint from a paint brush. The device can easily be removed from the can for cleaning.

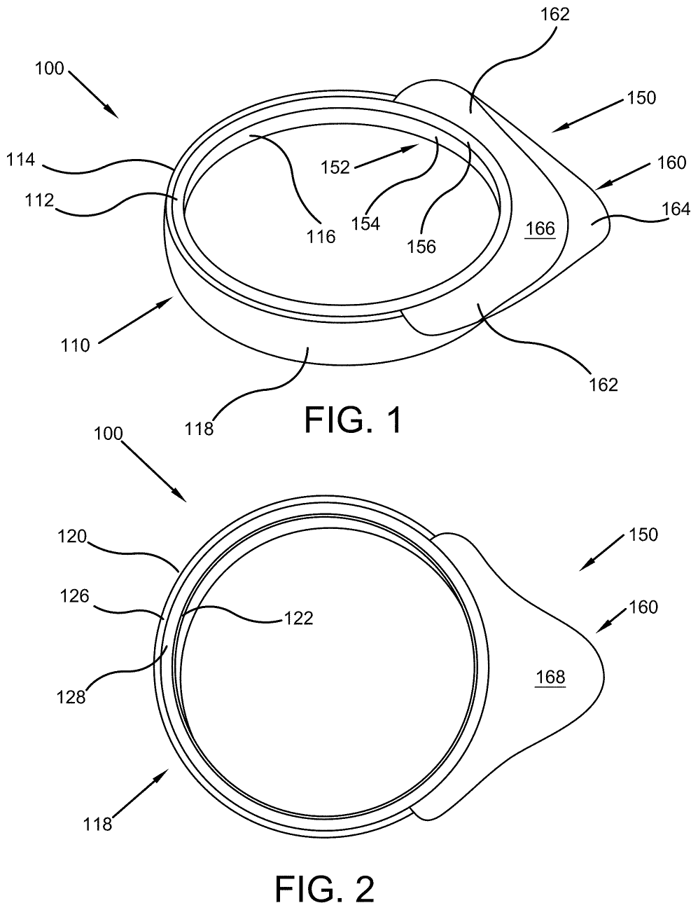

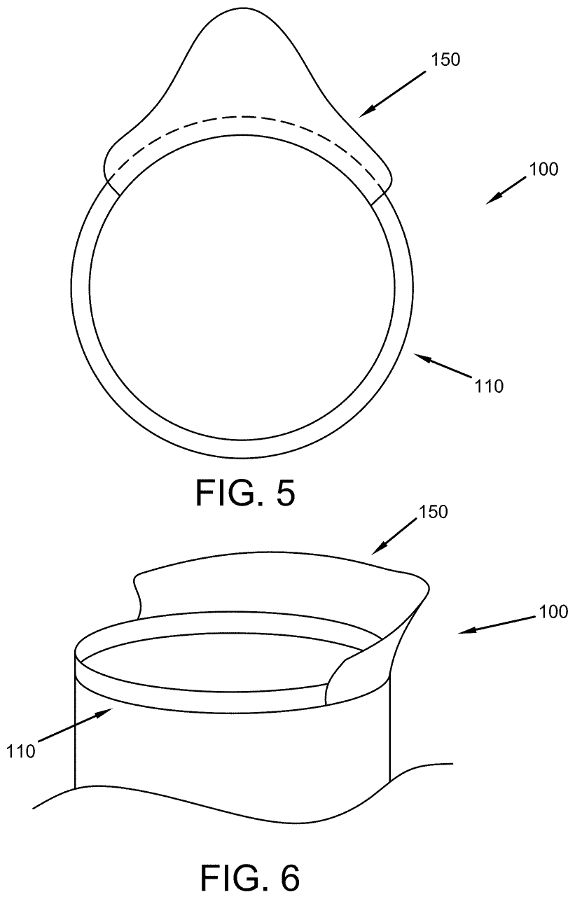

Referring initially to the drawings, FIGS. 1-11 illustrate a paint pouring device 100. The paint pouring device 100 may be manufactured in different sizes for use with traditional metal one gallon paint cans, newer plastic lid one gallon paint cans, five gallon paint buckets, or any other container with a circular rim containing liquid contents. The paint pouring device 100 is configured to attach and detach from a rim 12 and sidewall 14 of a paint can 10 quickly and easily. The paint pouring device 100 may be easily cleaned once detached from the paint can 10 with water, soap and water, or any other cleaning agent.

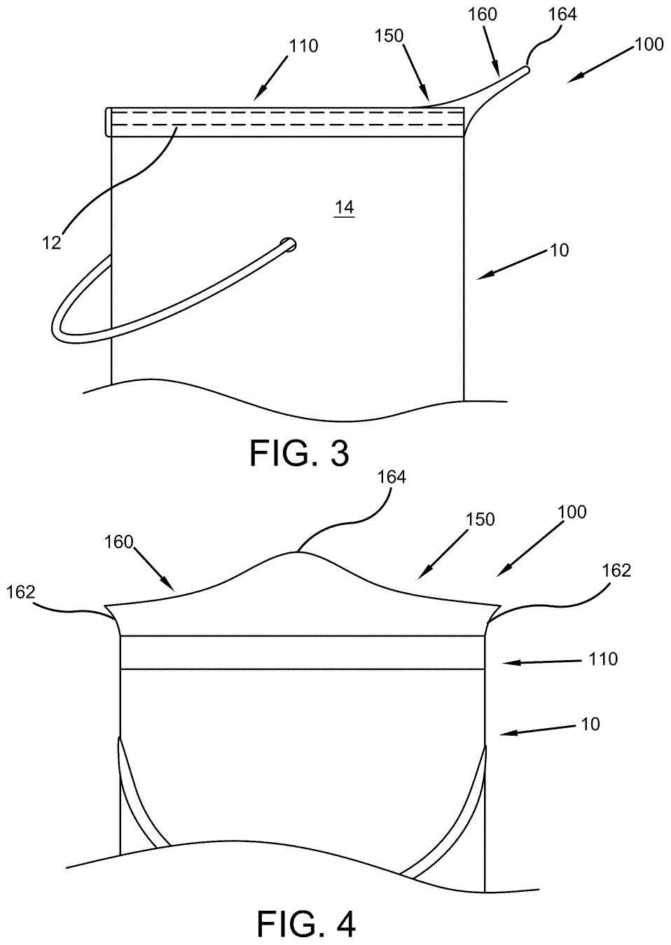

As illustrated in FIGS. 1, 5, and 7, the paint pouring device 100 comprises a cylindrical body 110 and a paint pouring guide 150 as illustrated in FIGS. 3, 4, and 6. The cylindrical body 110 is configured to fit over the rim 12 and frictionally engage the sidewall 14 of the paint can 10. The cylindrical body 110 is flexible and typically constructed of rubber, plastic, or similar polymer materials so that it can stretch and bend.

The cylindrical body 110 is generally ring shaped and comprises a top 112, and inner sidewall 116, and an outer sidewall 118. The inner and outer sidewalls 116 and 118 are connected along the top 112. The inner and outer sidewalls 116 and 118 are tall enough to extend down the sidewall 14 of the paint can 10 past the rim 12 and are at least ⅛^{th} of an inch tall. The top 112 may comprise a lip 114 or be beveled inward to prevent additional spills and is wide enough to extend over the rim 12 of the paint can 10. The lip 114 would extend around the cylindrical body 110 adjacent to the outer sidewall 118.

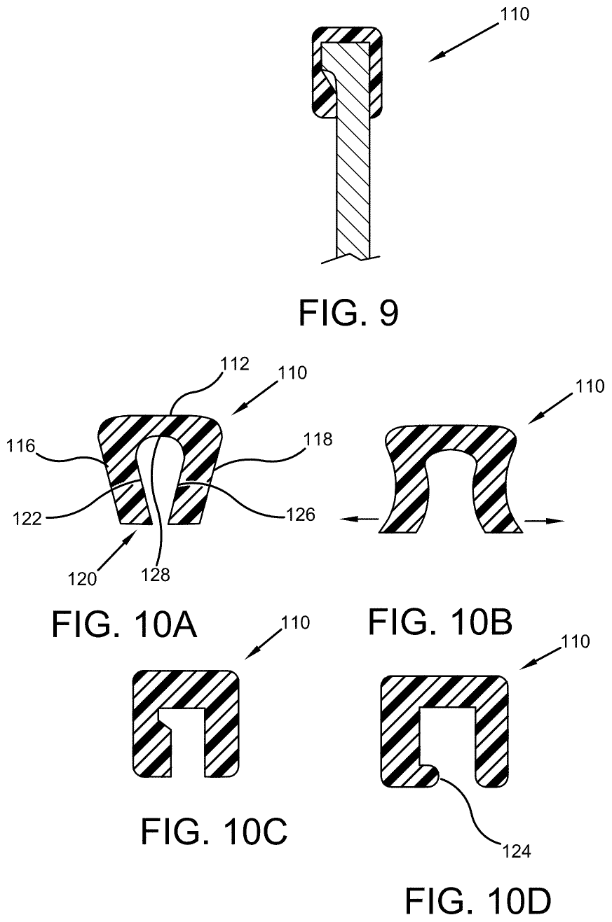

As illustrated in FIG. 2, the cylindrical body 110 further comprises a bottom 120. The bottom 120 is grooved or channeled to fit over the rim 12 of the paint can 10 as illustrated in FIG. 9. The bottom 120 is generally U-shaped or horseshoe shaped to accept the rim 12. As illustrated in FIGS. 10A-10D, the bottom 120 comprises an inner bottom sidewall 122 and an outer bottom sidewall 126. The inner and outer bottom sidewalls 122 and 126 are connected by a rim engaging portion 128. The inner and outer bottom sidewalls 122 and 126 are separated from each other, and with the rim engaging portion 128 form a groove, gap, or channel that fits around and frictionally engages the rim 12 and sidewall 14 of the paint can 10. As illustrated in FIG. 10B, the inner and outer bottom sidewalls 122 and 126 are deformable and push outward when placing the paint pouring device 100 on the rim 12 of the paint can 10. The inner and outer bottom sidewalls 122 are constructed from a material with a memory shape so that the inner and outer bottom sidewalls 122 return to their original position once in place on the rim 12 effectively creating a leak-proof seal as illustrated in FIG. 10A. As such, the inner and outer bottom sidewalls 122 slip on or snap in place. Alternatively, the outer or inner bottom sidewall 122 or 126 may be thinner adjacent to the rim engaging portion 128 to better seal over the rim 12 and sidewall 114 as illustrated in FIG. 10C.

As illustrated in FIG. 10D, the inner bottom sidewall 122 may comprise a sealing element 124. The sealing element 124 is a gasket or similar flexible member that seals the inner bottom sidewall 122 against the sidewall 14 of the paint can 10. The sealing element 124 further prevents paint leakage between the inner bottom sidewall 122 and the paint can sidewall 14.

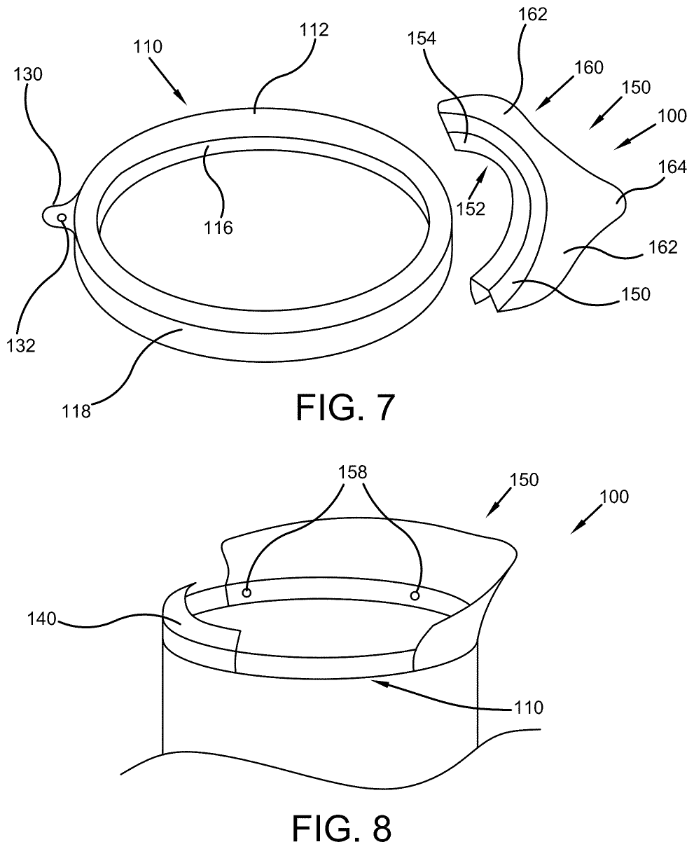

As illustrated in FIG. 7, the cylindrical body 110 may further comprise a handle 130. The handle 130 is oppositely disposed on the cylindrical body 110 to the paint pouring guide 150. The handle 130 may be integrated into or separately attachable to the cylindrical body 110. The handle 130 may comprise a hanging element 132. The hanging element 132 may be a hole or hanger integrated into the handle 130 to allow the paint pouring device 100 to be hung when not in use. As illustrated in FIG. 8, the cylindrical body 110 may further comprise a brush cleaning wall 140. The brush cleaning wall 140 extends upward from the top 112 of the inner sidewall 116 oppositely disposed on the cylindrical body 110 to the paint pouring guide 150. The brush cleaning wall 140 allows the user to clean paint from a paintbrush so that the paint is directed back into the paint can 10.

The paint pouring guide 150 comprises a curved body 152 and a pouring body 160. The paint pouring guide 150 extends upward and away from the cylindrical body 110. The curved body 152 comprises an inner sidewall engaging portion 154 and a top portion 156. The inner sidewall engaging portion 154 is positioned against and attached to a portion of the inner sidewall 116 of the cylindrical body 110. The top portion 156 fits and is attached to over a portion of the top 112 of the cylindrical body 110. The top portion 156, the inner sidewall engaging portion 154, or both may attach to the cylindrical body 110 via a plurality of attachment elements 158 as illustrated in FIG. 7. The plurality of attachment elements 158 may be mechanical fasteners or an adhesive. Alternatively, the curved body 152 may be integrated into the top 112 and inner sidewall 116 of the cylindrical body 110.

The pouring body 160 comprises a pair of wings 162 and a pour tip 164. The pair of wings 162 form a wedge or bend inward to terminates in the pour tip 164. The pour tip 164 may be a rubber lip or be constructed from a similar material as the rest of the paint pouring device 100. The pouring body 160 extends upward and away from the cylindrical body 110 and the curved body 152. The pouring body 160 may be malleable or flexible to adjustably direct a flow of paint out of the paint can 10, funnel it along a paint engaging surface 166 of the pouring body 160 across the wings 162, and over the pour tip 164. Alternatively, the pouring body 160 may be more rigid in construction. The paint is therefore channeled across the paint engaging surface 166 without dripping over on to an exterior surface 168 of the pouring body 160 when poured.

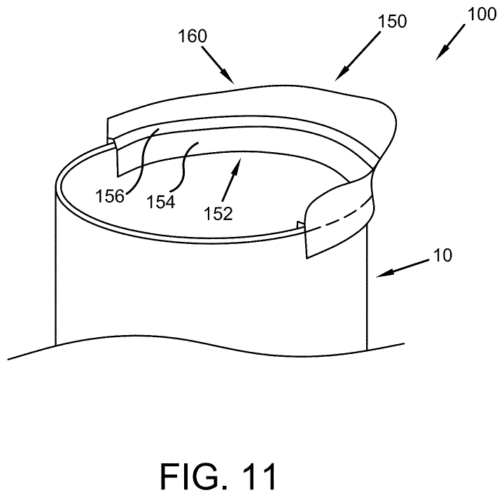

In an alternative embodiment as illustrated in FIG. 11, the paint pouring device 100 comprises a paint pouring guide 150 independent of the cylindrical body 110. The paint pouring guide 160 fits over a rim 12 and frictionally engages a sidewall 14 of a paint can 10. The paint pouring guide 150 comprises a curved body 152 and a pouring body 160 integrated with or attached to the curved body 152. The paint pouring guide 150 extends upward and away from the rim 12 of the paint can 10.

The curved body 152 comprises an inner sidewall engaging portion 154, an outer sidewall engaging portion 155, and a top portion 156. The top portion 156 connects the inner and outer sidewall engaging portions 154 and 155. The curved body 152 is grooved to fit over and frictionally engage a portion of the rim 12 of the paint 10 can similar to the bottom 120 of the cylindrical body 110 of the previous embodiment of the paint pouring device 100 as described supra.

The pouring body 160 comprises a pair of wings 162 and a pour tip 164. The pair of wings 162 form a wedge or bend inward to terminates in the pour tip 164. The pour tip 164 may be a rubber lip or be constructed from similar materials as the rest of the paint pouring device 100. The pouring body 160 extends upward and away from the curved body 152. The pouring body 160 may be malleable or flexible to adjustably direct a flow of paint out of the paint can 10, funnel it along a paint engaging surface 166 of the pouring body 160 across the wings 162, and over the pour tip 164. Alternatively, the pouring body 160 may be rigid in construction. The paint is therefore channeled across the paint engaging surface 166 without dripping over on to an exterior surface 168 of the pouring body 160 when poured.

Notwithstanding the forgoing, the paint pouring device 100 can be any suitable size, shape, and configuration as is known in the art without affecting the overall concept of the invention, provided that it accomplishes the above stated objectives. One of ordinary skill in the art will appreciate that the shape and size of the paint pouring device 100 and its various components, as show in the FIGS. are for illustrative purposes only, and that many other shapes and sizes of the paint pouring device 100 are well within the scope of the present disclosure. Although dimensions of the paint pouring device 100 and its components (i.e., length, width, and height) are important design parameters for good performance, the paint pouring device 100 and its various components may be any shape or size that ensures optimal performance during use and/or that suits user need and/or preference. As such, the paint pouring device 100 may be comprised of sizing/shaping that is appropriate and specific in regard to whatever the paint pouring device 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint pouring device comprising:
a cylindrical body comprising a top connecting an inner sidewall and an outer sidewall, and a bottom grooved to fit over a rim of a paint can;
a paint pouring guide attachable to the cylindrical body extending upward and away from the cylindrical body; and
wherein the cylindrical body is configured to frictionally engage the rim of the paint can.

2. The paint pouring device of claim 1, wherein the top of the cylindrical body comprises a lip extending around the cylindrical body adjacent to the outer sidewall.

3. The paint pouring device of claim 1, wherein the top of the cylindrical body is beveled inward.

4. The paint pouring device of claim 1, wherein the cylindrical body is flexible.

5. The paint pouring device of claim 1, wherein the bottom of the cylindrical body is U-shaped or horseshoe shaped.

6. The paint pouring device of claim 1, wherein the bottom of the cylindrical body comprises an inner bottom sidewall and an outer bottom sidewall.

7. The paint pouring device of claim 6, wherein the inner and outer bottom sidewalls each have a memory shape.

8. The paint pouring device of claim 6, wherein the inner and outer bottom sidewalls are deformable to fit over the rim and sidewall of the paint can.

9. The paint pouring device of claim 6, wherein the inner bottom sidewall comprises a sealing element.

10. The paint pouring device of claim 1, wherein the cylindrical body further comprises a handle oppositely disposed on the cylindrical body to the paint pouring guide.

11. The paint pouring device of claim 1, wherein the cylindrical body further comprises a brush cleaning wall extending upward from the top of the inner sidewall oppositely disposed on the cylindrical body to the paint pouring guide.

12. The paint pouring device of claim 1, wherein the paint pouring guide comprises a curved body attachable to the cylindrical body, and a pouring body extending upward and away from the cylindrical body.

13. The paint pouring device of claim 12, wherein the curved body attaches to a portion of the top and inner sidewall of the cylindrical body.

14. The paint pouring device of claim 12, wherein the curved body is integrated into a portion of the top and inner sidewall of the cylindrical body.

15. The paint pouring device of claim 12, wherein the pouring body comprises a pair of wings terminating in a pour tip for directing a flow of paint.

16. The paint pouring device of claim 12, wherein the pouring body is malleable.

17. The paint pouring device of claim 12, wherein the pouring body is rigid.

18. A paint pouring device comprising:
a flexible cylindrical body comprising a top connecting an inner sidewall and an outer sidewall, and a bottom comprising an inner bottom sidewall and an outer bottom sidewall separated to fit over a rim of a paint can;
a paint pouring guide comprising a curved body attachable to a portion of the top and inner sidewall of the cylindrical body, and a malleable pouring body extending upward and away from the curved body; and
wherein the inner and outer bottom sidewalls of the bottom of the cylindrical body are configured to frictionally engage the rim of the paint can.

19. The paint pouring device of claim 18, wherein the malleable pouring body comprises a pair of wings terminating in a pour tip for adjustably directing a flow of paint.

20. A paint pouring device comprising:
a paint pouring guide comprising:
a curved body comprising an inner sidewall and an outer sidewall grooved to fit over and frictionally engage a portion of a rim of a paint can; and
a pouring body comprising a pair of malleable wings terminating in a pour tip extending upward and away from the curved body for directing a flow of paint.
